(19) United States
(12) Patent Application Publication
(10) Pub. No.: US 2026/0244660 A1
(43) Pub. Date: Aug. 20, 2026

(54) ELECTRONIC DEVICE AND METHOD FOR PROCESSING USER UTTERANCE

(71) Applicant: Samsung Electronics Co., Ltd., Suwon-si (KR)

(72) Inventors: Sangmin PARK, Suwon-si (KR); Gajin SONG, Suwon-si (KR); Kyungtae KIM, Suwon-si (KR)

(21) Appl. No.: 19/642,147

(22) Filed: Apr. 8, 2026

Related U.S. Application Data
(63) Continuation of application No. PCT/KR2024/096264, filed on Oct. 10, 2024.

(30) Foreign Application Priority Data
Oct. 13, 2023 (KR) 10-2023-0136761
Nov. 20, 2023 (KR) 10-2023-0161534

(51) Int. Cl. G06F 16/3329; G06F 16/334; G10L 15/22

(52) U.S. Cl. CPC G06F 16/33295; G06F 16/334; G10L 15/22

(57) ABSTRACT

An electronic device and a method for processing a user utterance is provided. The method includes obtaining a plurality of first responses from different types of data sources based on the basis of an intent of a user utterance, selecting one or more first responses from among the plurality of first responses based on a correlation between each of the plurality of first responses and the user utterance, generating a prompt corresponding to the one or more first responses, outputting a second response based on a result output by a generative model using the prompt.

### CROSS-REFERENCE TO RELATED APPLICATION(S)

This application is a continuation application, claiming priority under 35 U.S.C. § 365(c), of an International application No. PCT/KR2024/096264, filed on October 10, 2024, which is based on and claims the benefit of a Korean patent application number 10-2023-0136761, filed on October 13, 2023 in the Ministry of Intellectual Property (MOIP), and of a Korean patent application number 10-2023-0161534, filed on November 20, 2023, in the Ministry of Intellectual Property (MOIP), the disclosure of each of which is incorporated by reference herein in its entirety.

### BACKGROUND

### 1. Field

The disclosure relates to an electronic device and a method of processing a user utterance.

### 2. Description of Related Art

A voice agent service (e.g., a voice assistant of Samsung) may sense a user utterance and may control an electronic device based on the user utterance.

The voice agent may provide a service to a user, based on various types of data sources and a plurality of neural network models (e.g., large language models).

The above information may be presented as the related art to help with the understanding of the disclosure. No arguments or decisions are raised to whether any of the above description is applicable as the prior art related to the present disclosure.

A user utterance may need to be processed using a data source and a neural network model corresponding to a feature (e.g., intents) of the user utterance to improve the usability of the voice agent.

The above information is presented as background information only to assist with an understanding of the disclosure. No determination has been made, and no assertion is made, as to whether any of the above might be applicable as prior art with regard to the disclosure.

### DISCLOSURE OF THE INVENTION

### Technical Solutions

Aspects of the disclosure are to address at least the above-mentioned problems and/or disadvantages and to provide at least the advantages described below. Accordingly, an aspect of the disclosure is to provide an electronic device and a method of processing a user utterance.

Additional aspects will be set forth in part in the description which follows and, in part, will be apparent from the description, or may be learned by practice of the presented embodiments.

In accordance with an aspect of the disclosure, an electronic device is provided. The electronic device includes at least one processor and memory, including one or more storage media, storing instructions, wherein the instructions, when executed by the at least one processor individually or collectively, cause the electronic device to obtain a plurality of first responses from different types of data sources based on an intent of a user utterance, select one or more first responses from the plurality of first responses based on a correlation between each of the plurality of first responses and the user utterance, generate a prompt corresponding to the one or more first responses, and output a second response based on a result output by a generative model using the prompt.

In accordance with another aspect of the disclosure, a method of operating an electronic device is provided. The method includes obtaining a plurality of first responses from different types of data sources based on an intent of a user utterance, selecting one or more first responses from the plurality of first responses based on a correlation between each of the plurality of first responses and the user utterance, and generating a prompt corresponding to the one or more first responses, and outputting a second response based on a result output by a generative model using the prompt.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include obtaining a plurality of first responses from different types of data sources based on an intent of a user utterance, selecting one or more first responses from the plurality of first responses based on a correlation between each of the plurality of first responses and the user utterance, generating a prompt corresponding to the one or more first responses, and outputting a second response based on a result output by a generative model using the prompt.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an integrated intelligence system according to an embodiment of the disclosure;

FIG. 3 is a diagram illustrating a form in which relationship information between concepts and actions is stored in a database according to an embodiment of the disclosure;

FIG. 4 is a diagram illustrating a screen of an electronic device processing a voice input received through an intelligent app, according to an embodiment of the disclosure;

FIG. 5 is a block diagram illustrating a user utterance processing system according to an embodiment of the disclosure;

FIG. 6 is a flowchart illustrating a user utterance processing system according to an embodiment of the disclosure;

FIG. 7 is a flowchart illustrating a user utterance processing system according to an embodiment of the disclosure;

FIGS. 8, 9 and 10 are diagrams illustrating a user interface and an operation of an electronic device according to various embodiments of the disclosure; and

FIG. 11 is a flowchart illustrating an operation of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

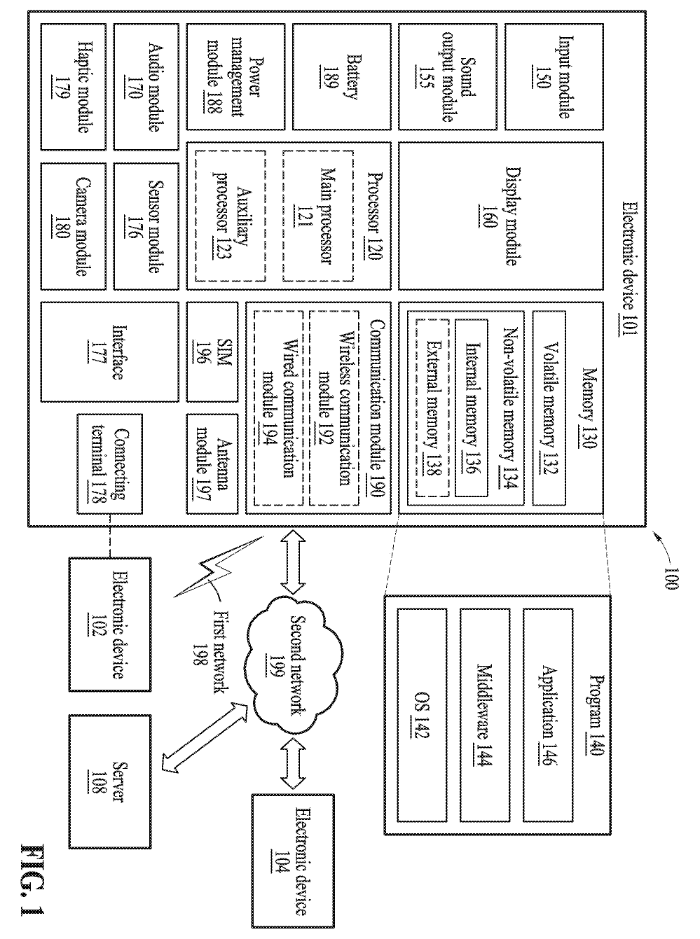

FIG. 1 is a block diagram illustrating an electronic device in a network environment according to an embodiment of the disclosure. Referring to FIG. 1, the electronic device 101 in the network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added to the electronic device 101. In some embodiments of the disclosure, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment of the disclosure, as at least a part of data processing or computation, the processor 120 may store a command or data received from another component (e.g., the sensor module 176 or the communication module 190) in volatile memory 132, process the command or the data stored in the volatile memory 132, and store resulting data in non-volatile memory 134.

According to an embodiment of the disclosure, the processor 120 may be implemented as circuitry (e.g., processing circuitry), such as system on chip (SoC) or an integrated circuit (IC). The processor 120 may include one or more processors. For example, the processor 120 may include a combination of one or more processors, such as a CPU, a GPU, a microprocessor unit (MPU), an AP, and a CP.

According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121 or to be dedicated for a designated function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., a sleep) state, or together with the main processor 121 while the main processor 121 is an active state (e.g., executing an application). According to an embodiment of the disclosure, the auxiliary processor 123 (e.g., an ISP or a CP) may be implemented as part of another component (e.g., the camera module 180 or the communication module 190) functionally related to the auxiliary processor 123. According to an embodiment of the disclosure, the auxiliary processor 123 (e.g., the NPU) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto.

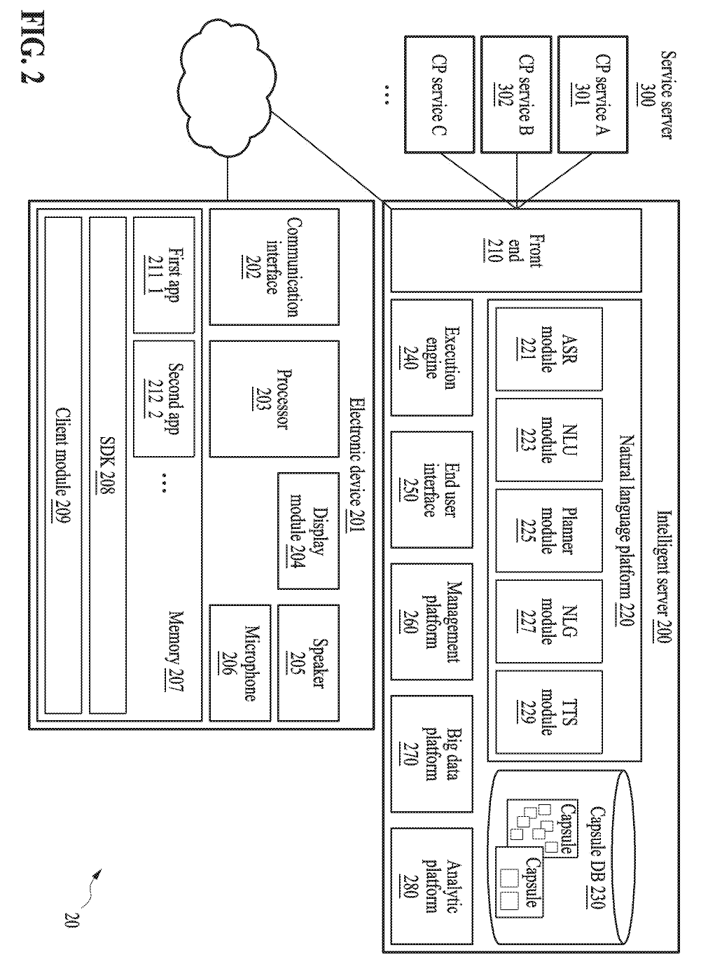

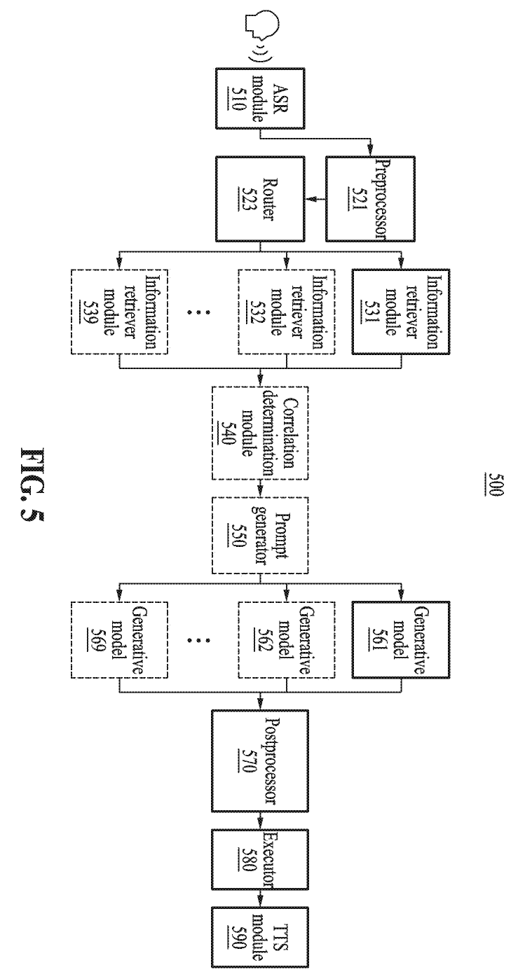

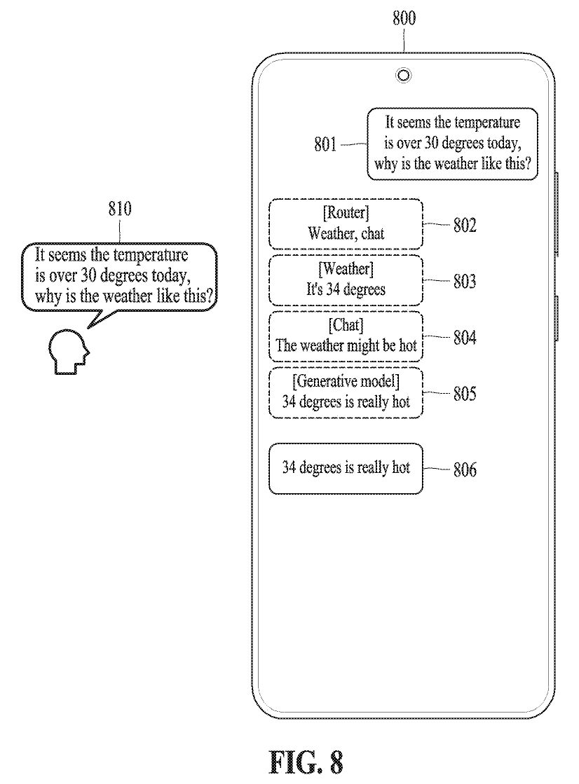

According to an embodiment of the disclosure, the memory 130 may include one or more memories. The instructions stored in the memory 130 may be stored in one memory. The instructions stored in the memory 130 may be divided and stored in a plurality of memories. The instructions stored in the memory 130, when individually or collectively executed by the processor 120, may cause an electronic device 101 (e.g., an electronic device 201 of FIG. 2 and an electronic device 800 of FIG. 8) to perform and/or control the user utterance processing method described with reference to FIGS. 5 to 11. The instructions stored in the memory 130, when individually or collectively executed by a plurality of processors, may cause an electronic device 101 (e.g., an electronic device 201 of FIG. 2 and an electronic device 800 of FIG. 8) to perform and/or control the user utterance processing method described with reference to FIGS. 5 to 11. According to an embodiment of the disclosure, the memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or an external electronic device (e.g., the external electronic device 102 (e.g., a speaker or headphones) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly According to an embodiment of the disclosure, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image and moving images. According to an embodiment of the disclosure, the camera module 180 may include one or more lenses, image sensors, ISPs, or flashes.

The power management module 188 may manage power supplied to the electronic device 101. According to an embodiment of the disclosure, the power management module 188 may be implemented as, for example, at least a part of a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to an embodiment of the disclosure, the antenna module 197 may form a mmWave antenna module. According to an embodiment of the disclosure, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic apparatus 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on fifth generation (5G) communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. Terms, such as "first," "second," "first," or "second" may be used simply to distinguish one component from another and may not limit the components with respect to other aspects (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

FIG. 2 is a block diagram illustrating an integrated intelligence system according to an embodiment of the disclosure.

Referring to FIG. 2, an integrated intelligence system 20 according to an embodiment may include an electronic device 201 (e.g., the electronic device 101 of FIG. 1), an intelligent server 200 (e.g., the server 108 of FIG. 1), and a service server 300 (e.g., the server 108 of FIG. 1), which may include CP service A 301 and CP service B 302.

The electronic device 201 of an embodiment may be a terminal device (or an electronic device) connectable to the Internet, and may be, for example, a mobile phone, a smartphone, a personal digital assistant (PDA), a notebook computer, a television (TV), a white home appliance, a wearable device, a head-mounted display (HMD), or a smart speaker.

According to the shown embodiment of the disclosure, the electronic device 201 may include a communication interface 202 (e.g., the interface 177 of FIG. 1), a microphone 206 (e.g., the input module 150 of FIG. 1), a speaker 205 (e.g., the sound output module 155 of FIG. 1), a display module 204 (e.g., the display module 160 of FIG. 1), memory 207 (e.g., the memory 130 of FIG. 1), or a processor 203 (e.g., the processor 120 of FIG. 1). The components listed above may be operatively or electrically connected to each other.

The communication interface 202 of an embodiment may be connected to an external device and configured to transmit and receive data to and from the external device. The microphone 206 of an embodiment may receive a sound (e.g., a user utterance) and convert the sound into an electrical signal. The speaker 205 of an embodiment may output the electrical signal as a sound (e.g., a voice).

The display module 204 of an embodiment may be configured to display an image or video. The display module 204 of an embodiment may also display a graphical user interface (GUI) of an app (or an application program) being executed. The display module 204 of an embodiment may receive a touch input through a touch sensor. For example, the display module 204 may receive a text input through the touch sensor in an on-screen keyboard area displayed on the display module 204.

The memory 207 of an embodiment may store a client module 209, a software development kit (SDK) 208, and a plurality of apps 210. The client module 209 and the SDK 208 may configure a framework (or a solution program) for performing general-purpose functions. In addition, the client module 209 or the SDK 208 may configure a framework for processing a user input (e.g., a voice input, a text input, or a touch input).

The plurality of apps 210 stored in the memory 207 of an embodiment may be programs for performing designated functions. According to an embodiment of the disclosure, the plurality of apps 210 may include a first app 211_1, and a second app 211_2. According to an embodiment of the disclosure, each of the plurality of apps 210 may include a plurality of actions for performing a designated function. For example, the apps may include an alarm app, a messaging app, and/or a scheduling app. According to an embodiment of the disclosure, the plurality of apps 210 may be executed by the processor 203 to sequentially execute at least a portion of the plurality of actions.

The processor 203 of an embodiment of the disclosure may control the overall operation of the electronic device 201. For example, the processor 203 may be electrically connected to the communication interface 202, the microphone 206, the speaker 205, and the display module 204 to perform a designated operation.

According to an embodiment of the disclosure, the processor 203 may be implemented as circuitry (e.g., processing circuitry), such as an SoC or an IC. The processor 203 may include one or more processors. For example, the processor 203 may include a combination of one or more processors, such as a CPU, a GPU, an MPU, an AP, and a CP.

The processor 203 of an embodiment may also perform the designated function by executing the program stored in the memory 207. For example, the processor 203 may execute at least one of the client module 209 or the SDK 208 to perform the following operation for processing a user input. The processor 203 may control the actions of the plurality of apps 210 through, for example, the SDK 208. The following operation described as an operation of the client module 209 or the SDK 208 may be an operation by an execution of the processor 203.

According to an embodiment of the disclosure, the memory 207 may include one or more memories. The instructions stored in the memory 207 may be stored in a single memory. The instructions stored in the memory 207 may be divided and stored in a plurality of memories. The instructions stored in the memory 207 may be executed by the processor 203 individually or collectively to cause the electronic device 201 (e.g., the electronic device 101 of FIG. 1 and an electronic device 800 of FIG. 8) to perform and/or control the method of processing a user utterance described with reference to FIGS. 5 to 11. The instructions stored in the memory 207 may be executed by a plurality of processors individually or collectively to cause the electronic device 201 (e.g., the electronic device 101 of FIG. 1 and the electronic device 800 of FIG. 8) to perform and/or control the method of processing a user utterance described with reference to FIGS. 5 to 11.

The client module 209 of an embodiment may receive a user input. For example, the client module 209 may receive a voice signal corresponding to a user utterance sensed through the microphone 206. In another example, the client module 209 may receive a touch input sensed through the display module 204. In still another example, the client module 209 may receive a text input sensed through a keyboard or an on-screen keyboard. In addition, the client module 209 may receive various types of user inputs sensed through an input module included in the electronic device 201 or an input module connected to the electronic device 201. The client module 209 may transmit the received user input to the intelligent server 200. The client module 209 may transmit state information of the electronic device 201 together with the received user input to the intelligent server 200. The state information may be, for example, execution state information of an app.

The client module 209 of an embodiment may receive a result corresponding to the received user input. For example, when the intelligent server 200 is capable of calculating a result corresponding to the received user input, the client module 209 may receive the result corresponding to the received user input. The client module 209 may display the received result on the display module 204. Furthermore, the client module 209 may output the received result in an audio form through the speaker 205.

The client module 209 of an embodiment of the disclosure may receive a plan corresponding to the received user input. The client module 209 may display, on the display module 204, the results of executing a plurality of actions of an app according to the plan. For example, the client module 209 may sequentially display the results of executing the plurality of actions on the display module 204 and output the results in an audio form through the speaker 205. In another example, the electronic device 201 may display only a portion of the results of executing the plurality of actions (e.g., a result of the last action) on the display module 204 and output the portion of the results in an audio form through the speaker 205.

According to an embodiment of the disclosure, the client module 209 may receive a request for obtaining information necessary for calculating a result corresponding to the user input from the intelligent server 200. According to an embodiment of the disclosure, the client module 209 may transmit the necessary information to the intelligent server 200 in response to the request.

The client module 209 of an embodiment may transmit information on the results of executing the plurality of actions according to the plan to the intelligent server 200. The intelligent server 200 may confirm that the received user input is correctly processed using the information on the results.

The client module 209 of an embodiment may include a speech recognition module. According to an embodiment of the disclosure, the client module 209 may recognize, through the speech recognition module, a voice input for performing a limited function. For example, the client module 209 may execute an intelligent app for processing a voice input to perform an organic operation through a designated input (e.g., Wake up!).

The intelligent server 200 of an embodiment may receive information regarding a user voice input from the electronic device 201 through a communication network. According to an embodiment of the disclosure, the intelligent server 200 may change data regarding the received voice input into text data. According to an embodiment of the disclosure, the intelligent server 200 may generate a plan for performing a task corresponding to the user voice input, based on the text data.

According to an embodiment of the disclosure, the plan may be generated by an AI system. The AI system may be a rule-based system or a neural network-based system (e.g., a feedforward neural network (FNN) or an RNN). Alternatively, the AI system may be a combination thereof or other AI systems. According to an embodiment of the disclosure, the plan may be selected from a set of pre-defined plans or may be generated in real time in response to a user request. For example, the AI system may select at least one plan from the pre-defined plans.

The intelligent server 200 of an embodiment of the disclosure may transmit a result according to the generated plan to the electronic device 201 or transmit the generated plan to the electronic device 201. According to an embodiment of the disclosure, the electronic device 201 may display the result according to the plan on the display module 204. According to an embodiment of the disclosure, the electronic device 201 may display a result of executing an action according to the plan on the display module 204.

The intelligent server 200 of an embodiment of the disclosure may include a front end 215, a natural language platform 220, a capsule database (DB) 230, an execution engine 240, an end user interface (UI) 250, a management platform 260, a big data platform 270, or an analytic platform 280.

The front end 215 of an embodiment of the disclosure may receive a user input received from the electronic device 201. The front end 215 may transmit a response corresponding to the user input.

According to an embodiment of the disclosure, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 of an embodiment may convert a voice input received from the electronic device 201 into text data. The NLU module 223 of an embodiment may identify the intent of the user using the text data of the voice input. For example, the NLU module 223 may identify the intent of the user by performing syntactic analysis or semantic analysis on an input of the user in the form of text data. The NLU module 223 of an embodiment may identify the meaning of a word extracted from the input of the user using a linguistic feature (e.g., a grammatical element) of a morpheme or a phrase and may determine the intent of the user by matching the identified meaning of the word to the intent.

The planner module 225 of an embodiment may generate a plan using the intent determined by the NLU module 223 and a parameter. According to an embodiment of the disclosure, the planner module 225 may determine a plurality of domains necessary for a task based on the determined intent. The planner module 225 may determine a plurality of actions included in each of the plurality of domains determined based on the intent. According to an embodiment of the disclosure, the planner module 225 may determine a parameter necessary for the determined plurality of actions, or a result value output by the execution of the plurality of actions. The parameter, and the result value may be defined as a concept of a designated form (or class). Accordingly, the plan may include a plurality of actions and a plurality of concepts determined by the intent of the user. The planner module 225 may determine relationships between the plurality of actions and the plurality of concepts stepwise (or hierarchically. For example, the planner module 225 may determine an execution order of the plurality of actions determined based on the intent of the user, based on the plurality of concepts. For example, the planner module 225 may determine the execution order of the plurality of actions based on the parameter necessary for the execution of the plurality of actions and results output by the execution of the plurality of actions. Accordingly, the planner module 225 may generate a plan including connection information (e.g., ontology) on connections between the plurality of actions and the plurality of concepts. The planner module 225 may generate the plan using information stored in the capsule DB 230 that stores a set of relationships between concepts and actions.

The NLG module 227 of an embodiment may change designated information into a text form. The information changed to the text form may be in the form of a natural language utterance. The TTS module 229 of an embodiment may change information in a text form into information in a voice form.

According to an embodiment of the disclosure, some or all the functions of the natural language platform 220 may be implemented in the electronic device 201 as well.

The capsule DB 230 may store information on the relationships between the plurality of concepts and actions corresponding to the plurality of domains. A capsule according to an embodiment may include a plurality of action objects (or action information) and concept objects (or concept information) included in the plan. According to an embodiment of the disclosure, the capsule DB 230 may store a plurality of capsules in the form of a concept action network (CAN). According to an embodiment of the disclosure, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when a plurality of plans corresponding to the user input is present. According to an embodiment of the disclosure, the capsule DB 230 may include a follow-up registry that stores information on follow-up actions for suggesting a follow-up action to the user in a designated situation. The follow-up action may include, for example, a follow-up utterance. According to an embodiment of the disclosure, the capsule DB 230 may include a layout registry that stores layout information that is information output through the electronic device 201. According to an embodiment of the disclosure, the capsule DB 230 may include a vocabulary registry that stores vocabulary information included in capsule information. According to an embodiment of the disclosure, the capsule DB 230 may include a dialog registry that stores information regarding a dialog (or an interaction) with the user. The capsule DB 230 may update the stored objects through a developer tool. The developer tool may include, for example, a function editor for updating an action object or a concept object. The developer tool may include a vocabulary editor for updating a vocabulary. The developer tool may include a strategy editor for generating and registering a strategy for determining a plan. The developer tool may include a dialog editor for generating a dialog with the user. The developer tool may include a follow-up editor capable of activating a subsequent goal and editing a subsequent utterance that provides hints. The subsequent goal may be determined based on a currently configured goal, a preference of the user, or an environmental condition. In an embodiment of the disclosure, the capsule DB 230 may be implemented in the electronic device 201 as well.

The execution engine 240 may calculate a result using the generated plan. The end UI 250 may transmit the calculated result to the electronic device 201. Accordingly, the electronic device 201 may receive the result and provide the received result to the user. The management platform 260 of an embodiment may manage information used by the intelligent server 200. The big data platform 270 of an embodiment may collect data of the user. The analytic platform 280 of an embodiment may manage a quality of service (QoS) of the intelligent server 200. For example, the analytic platform 280 may manage the components and processing rate (or efficiency) of the intelligent server 200.

The service server 300 of an embodiment may provide a service (e.g., food ordering or hotel reservation) designated to the electronic device 201. According to an embodiment of the disclosure, the service server 300 may be a server operated by a third party. The service server 300 of an embodiment of the disclosure may provide, to the intelligent server 200, information to be used for generating a plan corresponding to the received user input. The provided information may be stored in the capsule DB 230. In addition, the service server 300 may provide result information according to the plan to the intelligent server 200.

In the integrated intelligence system 20 described above, the electronic device 201 may provide various intelligent services to the user in response to the user input. The user input may include, for example, an input through a physical button, a touch input, or a voice input.

In an embodiment of the disclosure, the electronic device 201 may provide a speech recognition service through an intelligent app (or a speech recognition app) stored therein. In this case, for example, the electronic device 201 may recognize a user utterance or a voice input received through the microphone and provide a service corresponding to the recognized voice input to the user.

In an embodiment of the disclosure, the electronic device 201 may perform a designated action alone or together with the intelligent server and/or the service server, based on the received voice input. For example, the electronic device 201 may execute an app corresponding to the voice input and perform a designated action through the executed app.

In an embodiment of the disclosure, when the electronic device 201 provides a service together with the intelligent server 200 and/or the service server 300, the electronic device 201 may detect a user utterance using the microphone 206 and generate a signal (or voice data) corresponding to the detected user utterance. The electronic device 201 may transmit the voice data to the intelligent server 200 using the communication interface 202.

The intelligent server 200 according to an embodiment may generate, as a response to the voice input received from the electronic device 201, a plan for performing a task corresponding to the voice input or a result of performing an action according to the plan. The plan may include, for example, the plurality of actions for performing the task corresponding to the voice input of the user and the plurality of concepts associated with the plurality of actions. The concepts may be defined as parameters that are input for execution of the plurality of actions or result values that are output by execution of the plurality of actions. The plan may include connection information on connections between the plurality of actions and the plurality of concepts.

The electronic device 201 of an embodiment may receive the response using the communication interface 202. The electronic device 201 may output a voice signal generated inside the electronic device 201 to the outside using the speaker 205 or may output an image generated inside the electronic device 201 to the outside using the display module 204.

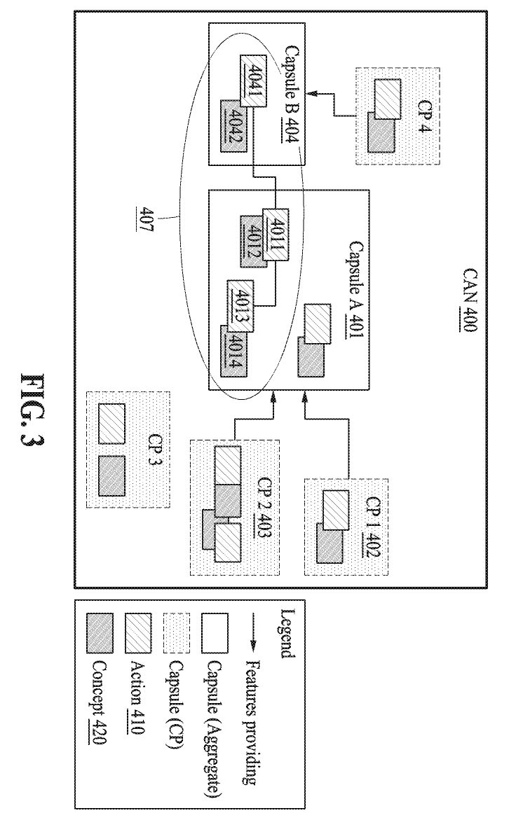

FIG. 3 is a diagram illustrating a form in which relationship information between concepts and actions is stored in a DB according to an embodiment of the disclosure.

A capsule DB (e.g., the capsule DB 230) of the intelligent server 200 may store capsules in the form of a CAN 400. The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains (e.g., apps). According to an embodiment of the disclosure, one capsule (e.g., the capsule A 401) may correspond to one domain (e.g., a location (geo) or an app). Furthermore, one capsule may correspond to at least one service provider (e.g., CP 1 402 or CP 2 403) for performing a function for a domain related to the capsule. According to an embodiment of the disclosure, one capsule may include at least one action 410 and at least one concept 420 to perform a designated function.

The natural language platform 220 may generate a plan for performing a task corresponding to the received voice input, using the capsules stored in the capsule DB. For example, the planner module 225 of the natural language platform may generate a plan using the capsules stored in the capsule DB. For example, a plan 407 may be generated using actions 4011 and 4013 and concepts 4012 and 4014 of the capsule A 401 and an action 4041 and a concept 4042 of the capsule B 404.

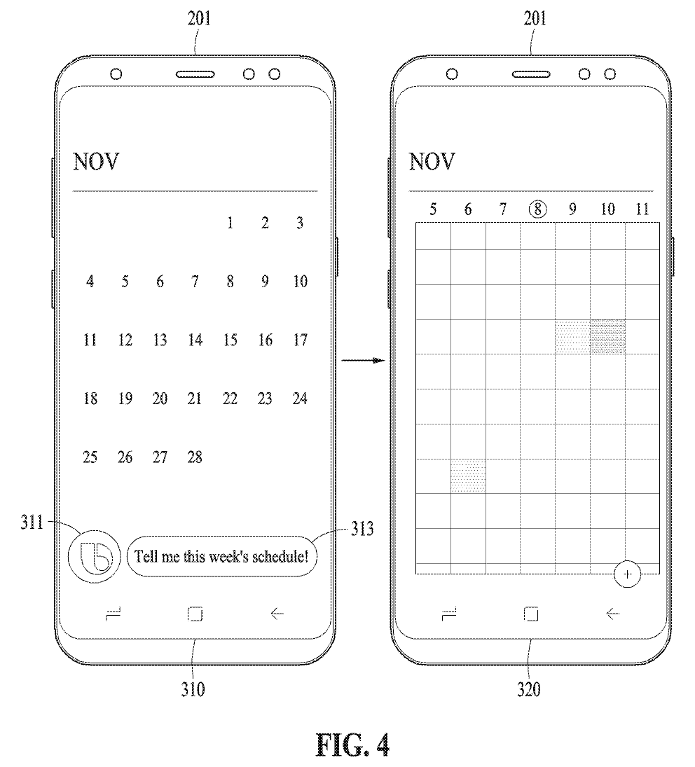

FIG. 4 is a diagram illustrating a screen in which an electronic device processes a voice input received through an intelligent app according to an embodiment of the disclosure.

The electronic device 201 may execute an intelligent app to process a user input through the intelligent server 200.

According to an embodiment of the disclosure, on a screen 310, when a designated voice input (e.g., Wake up!) is recognized or an input through a hardware key (e.g., a dedicated hardware key) is received, the electronic device 201 may execute the intelligent app for processing the voice input. The electronic device 201 may execute the intelligent app, for example, in a state in which a scheduling app is executed. According to an embodiment of the disclosure, the electronic device 201 may display an object (e.g., an icon) 311 corresponding to the intelligent app on the display module 204. According to an embodiment of the disclosure, the electronic device 201 may receive a voice input by a user utterance. For example, the electronic device 201 may receive a voice input of "Tell me this week's schedule!" According to an embodiment of the disclosure, the electronic device 201 may display, on the display module 204, a UI 313 (e.g., an input window) of the intelligent app in which text data of the received voice input is displayed.

According to an embodiment of the disclosure, on a screen 320, the electronic device 201 may display a result corresponding to the received voice input on the display module 204. For example, the electronic device 201 may receive a plan corresponding to the received user input and display "This week's schedule" on the display module 204 according to the plan.

FIG. 5 is a block diagram illustrating a user utterance processing system according to an embodiment of the disclosure.

Referring to FIG. 5, according to an embodiment of the disclosure, a user utterance processing system 500 may be implemented in an electronic device (e.g., the electronic device 101 of FIG. 1 and the electronic device 201 of FIG. 2) or a server (e.g., the intelligent server 200 of FIG. 2) that communicates with the electronic device 101 or 201.

According to an embodiment of the disclosure, some of components (or functions) of the user utterance processing system 500 may be implemented in the electronic device 101 or 201, and the other components may be implemented in the server 200.

According to an embodiment of the disclosure, the user utterance processing system 500 may include an ASR module 510 (e.g., the ASR module 221 of FIG. 2), a preprocessor 521, a router 523, one or more information retriever modules 531 to 539, a correlation determination module 540, a prompt generator 550, one or more generative models 561 to 569, a postprocessor 570, an executor 580, and a text-to-speech (TTS) module 590 (e.g., the TTS module 229 of FIG. 2).

According to an embodiment of the disclosure, the ASR module 510 may convert audio data corresponding to a user utterance into text.

According to an embodiment of the disclosure, the preprocessor 521 may perform text preprocessing. For example, the preprocessor 521 may remove an unnecessary word and/or a special character (e.g., a comma) from the text.

According to an embodiment of the disclosure, based on a feature (e.g., intents) of the user utterance, the router 523 may input the text (e.g., preprocessed text) corresponding to the user utterance to a corresponding information retriever module.

According to an embodiment of the disclosure, the router 523 may include a neural network. The router 523 may be trained to select one or more information retriever modules corresponding to the feature (e.g., intents) of the user utterance from the information retriever modules 531 to 539 and input text to the selected information retriever modules. The router 523 may be trained based on supervised learning and/or unsupervised learning (e.g., reinforcement learning from human feedback (RLHF) and rule-based learning). The supervised learning may be based on features (e.g., types) of the information retriever modules 531 to 539.

According to an embodiment of the disclosure, based on the feature (e.g., intents) of the user utterance, the router 523 may input the entire text to one or more corresponding information retriever modules. For example, when the user utterance (e.g., "How is the weather this morning? Will it rain this afternoon?") includes a plurality of sentences and intents of the plurality of sentences are the same and/or similar to each other, the router 523 may input the entire text corresponding to the user utterance to one or more corresponding information retriever modules.

According to an embodiment of the disclosure, based on the feature (e.g., intents or formation) of the user utterance, the router 523 may input parts of the text corresponding to the user utterance to one or more corresponding information retriever modules, respectively. For example, when a user utterance (e.g., "Set the front door password to Dad's birthday") includes a plurality of intents and there is no or low correlation among the plurality of intents, the router 523 may separate text corresponding to the user utterance into a plurality of texts (e.g., "Tell me dad's birthday", "Set the front door password"). The router 523 may input the separated texts to corresponding information retriever modules, respectively. In another example, when the user utterance (e.g., "Tell me the weather today. Call my mom.") includes a plurality of separable sentences, the router 523 may separate text corresponding to the user utterance into a plurality of texts (e.g., "Tell me the weather today", "Call my mom"). The router 523 may input each of the separated texts to one or more corresponding information retriever modules.

According to an embodiment of the disclosure, the information retriever modules 531 to 539 may generate a response (e.g., text, an embedding vector, code, or javascript object notation (JSON)) corresponding to an input. Each of the information retriever modules may use a corresponding data source to generate the response. For example, each of the information retriever modules may obtain data from a repository related to a specific application (e.g., a user schedule management application, such as a calendar) and/or a data source, such as a website. Some of the information retriever modules 531 to 539 may be first information retriever modules for processing one domain, and the others may be second information retriever modules for processing domains. Each of the information retriever modules 531 to 539 may input the generated response to the correlation determination module 540.

According to an embodiment of the disclosure, the correlation determination module 540 may determine the correlation between each of the responses generated by the information retriever modules and the user utterance (e.g., intents of the user utterance). For example, the correlation determination module 540 may determine the correlation by normalizing a relationship between each of the responses and an intent of the user utterance. The correlation determination module 540 may select one or more responses based on the correlation. For example, the correlation determination module 540 may select responses including information related to the user utterance (e.g., the intent of the user utterance) from the responses generated by the information retriever module. The correlation determination module 540 may not select responses (e.g., "Unable to answer weather", "Unknown contact") that do not include the information related to the user utterance. The correlation determination module 540 may input the selected responses to the prompt generator 550.

According to an embodiment of the disclosure, the correlation determination module 540 may include a neural network. The correlation determination module 540 may be trained to select a candidate response including the information related to the user utterance (e.g., the intent of the user utterance) from candidate responses. The correlation determination module 540 may be trained based on supervised learning, semi-supervised learning, and/or unsupervised learning (e.g., RLHF).

According to an embodiment of the disclosure, a function of the correlation determination module 540 may be performed by the information retriever modules 531 to 539. In this case, the correlation determination module 540 may be omitted.

According to an embodiment of the disclosure, based on a system policy, the prompt generator 550 may generate data (e.g., a prompt) using the responses selected by the correlation determination module 540. The data may be input to a generative model (e.g., a large language model). For example, the prompt generator 550 may generate the data using the selected responses and a description (e.g., a prompt description) corresponding to the selected responses. The description may include an instruction and/or information for a combination of different types of responses, such as natural language, code, and JSON.

According to an embodiment of the disclosure, the prompt generator 550 may select generative models for processing the generated data (e.g., the prompt) from one or more generative models 561 to 569. The prompt generator 550 may select the generative models based on information about the generated prompt. For example, the prompt generator 550 may use the length, complexity, and type (e.g., a question, a query, data manipulation, classification, code generation, translation, and idea generation) of the generated prompt to select the generative models. The prompt generator 550 may select the generative models for processing the data (e.g., the prompt) that is generated based on the information about the generative models 561 to 569. For example, to select the generative models, the prompt generator 550 may use the cost, performance (e.g., a response time and response accuracy), type (e.g., on-device artificial intelligence (AI) or server-based AI), and response characteristics of the generative models 561 to 569. The prompt generator 550 may input the generated data (e.g., the prompt) to the selected generative model.

According to an embodiment of the disclosure, a function of the prompt generator 550 may be performed by the information retriever modules 531 to 539. In this case, the prompt generator 550 may be omitted.

According to an embodiment of the disclosure, each of the generative models 561 to 569 may generate a response corresponding to an input (e.g., the prompt) using a neural network (e.g., a deep learning model). Each of the generative models 561 to 569 may input the generated response to the postprocessor 570.

According to an embodiment of the disclosure, the postprocessor 570 may perform postprocessing on the response generated by the generative model. The postprocessor 570 may select a response from the responses generated by the generative models. For example, the postprocessor 570 may process (e.g., remove) a response (e.g., AI hallucination) that is irrelevant to the user utterance from the responses generated by the generative models.

According to an embodiment of the disclosure, the postprocessor 570 may generate one response from the responses generated by the generative models. For example, the postprocessor 570 may generate one response by processing responses based on the intent of the user utterance.

According to an embodiment of the disclosure, the postprocessor 570 may include a neural network.

According to an embodiment of the disclosure, the postprocessor 570 may input a postprocessed response (e.g., the selected response) to the executor 580.

According to an embodiment of the disclosure, the executor 580 may perform various operations based on an input (e.g., the postprocessed response). For example, the executor 580 may output, on a display, information (e.g., information related to a question (e.g., an answer)) related to the user utterance based on the input.

According to an embodiment of the disclosure, the TTS module 590 may convert text into audio data.

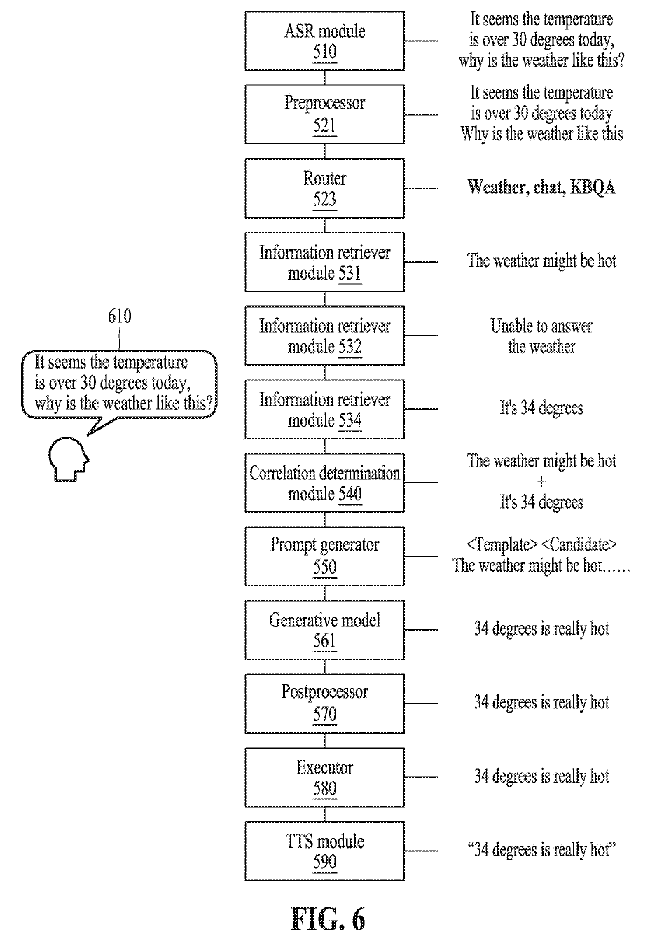

FIG. 6 is a flowchart illustrating a user utterance processing system according to an embodiment of the disclosure.

Referring to FIG. 6, according to an embodiment of the disclosure, a user utterance processing system (e.g., the user utterance processing system 500 of FIG. 5) may process a user utterance 610. The user utterance 610 may include intents, such as "a weather inquiry" and "a complaint about the weather".

According to an embodiment of the disclosure, the ASR module 510 may obtain text, "It seems the temperature is over 30 degrees today, why is the weather like this?", corresponding to the user utterance 610. The preprocessor 521 may remove a comma and a question mark from the text corresponding to the user utterance 610 by performing text preprocessing. The router 523 may input an entirety or a portion of the preprocessed text to a corresponding information retriever module based on the intent of the user utterance 610. For example, the router 523 may input the preprocessed text, "It seems the temperature is over 30 degrees today, why is the weather like this?", to the information retriever module 531 that is related to a chat, the information retriever module 532 that is related to knowledge base question answering (KBQA), and the information retriever module 534 that is related to the weather. Each of the information retriever modules 531, 532, and 534 may generate a response. The correlation determination module 540 may select a response related to the user utterance 610 from the responses generated by the information retriever modules 531, 532, and 534. For example, the correlation determination module 540 may select a chatty response, such as "The weather might be hot", and an informative response, such as "It is 34 degrees", while excluding a rejection response, such as "Unable to answer about the weather". The prompt generator 550 may generate a prompt based on the selected responses. The prompt generator 550 may generate a description (e.g., the prompt description) corresponding to the selected responses as necessary. The prompt generator 550 may generate the prompt by combining the selected responses with the generated description. The prompt generator 550 may select a generative model for processing the prompt, based on at least one of the length, complexity, and type of the prompt. The prompt generator 550 may input the prompt to the selected generative model (e.g., the generative model 561). The generative model 561 may generate a response, "34 degrees is really hot", by processing the prompt. The postprocessor 570 may postprocess the response generated by the generative model 561. An operation of the postprocessor 570 may be omitted. The executor 580 may output the text, "34 degrees is really hot", on a display. The TTS module 590 may convert the text, "34 degrees is really hot", into corresponding voice data.

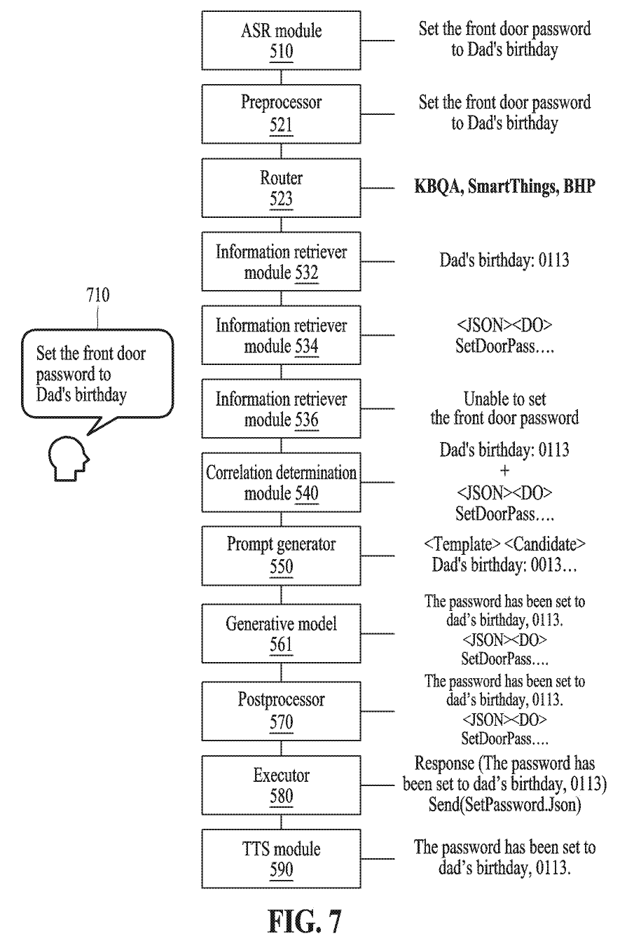

FIG. 7 is a flowchart illustrating a user utterance processing system according to an embodiment of the disclosure.

Referring to FIG. 7, according to an embodiment of the disclosure, a user utterance processing system (e.g., the user utterance processing system 500 of FIG. 5) may process a user utterance 710. The user utterance 710 may include a plurality of intents, such as a "birthday inquiry" and "setting a password of a front door". Among operations of the user utterance processing system 500 illustrated in FIG. 7, descriptions of operations that are substantially the same as the operations of the user utterance processing system 500 illustrated in FIG. 6 are omitted.

According to an embodiment of the disclosure, the user utterance processing system 500 may obtain different types of responses (e.g., informational text, code, and JSON) using information retriever modules 532, 535, and 536. The user utterance processing system 500 may generate a description (e.g., a prompt description) for a combination of different types of responses and may generate a prompt based on the responses and the description.

FIG. 8 is a diagram illustrating a user interface and an operation of an electronic device according to an embodiment of the disclosure.

Referring to FIG. 8, according to an embodiment of the disclosure, an electronic device 800 (e.g., the electronic device 101 of FIG. 1 and the electronic device 201 of FIGS. 2 and 4) may execute a voice agent application (e.g., a voice assistant) in response to sensing a user utterance 810. The electronic device 800 may process the user utterance 810 using a user utterance processing system (e.g., the user utterance processing system 500 of FIG. 5). The user utterance 810 may include an inquiry and a chitchat.

According to an embodiment of the disclosure, the electronic device 800 may output text 801 corresponding to the user utterance 810 on a display of the electronic device 800.

According to an embodiment of the disclosure, the electronic device 800 may select information retriever modules (e.g., a weather-related information retriever module and a chat-related information retriever module) corresponding to the user utterance 810 using a router (e.g., the router 523 of FIG. 5).

According to an embodiment of the disclosure, the electronic device 800 may generate a plurality of responses 803 and 804 by processing the text corresponding to the user utterance using the selected information retriever modules.

According to an embodiment of the disclosure, the electronic device 800 may generate a prompt using the plurality of responses 803 and 804. The electronic device 800 may generate a response 805 by processing the prompt using a corresponding generative model (e.g., a large language model). The electronic device 800 may output text 806 corresponding to the response 805 on the display of the electronic device 800.

According to an embodiment of the disclosure, the electronic device 800 may or may not display a list 802 of the information retriever modules selected by the router 523, the responses 803 and 804 generated by the selected information retriever modules, and/or the response 805 generated by the generative model, on the display of the electronic device 800.

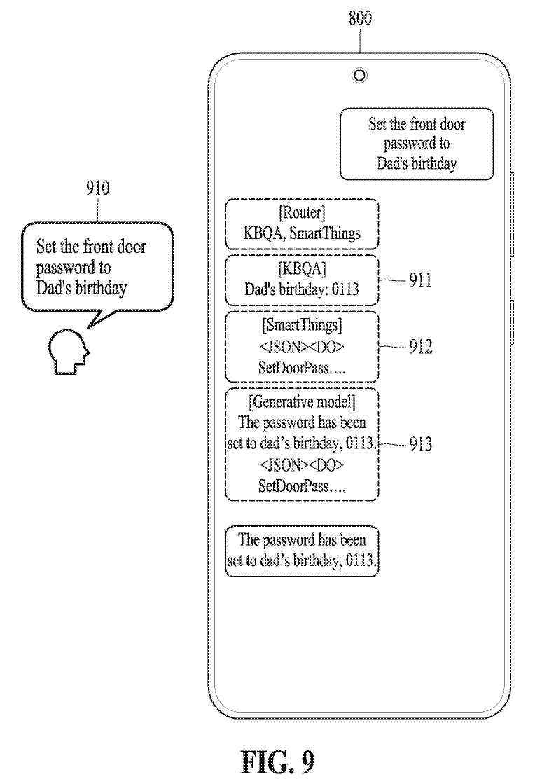

FIG. 9 is a diagram illustrating a user interface and an operation of an electronic device according to an embodiment of the disclosure.

Referring to FIG. 9, according to an embodiment of the disclosure, the electronic device 800 (e.g., the electronic device 101 of FIG. 1 and the electronic device 201 of FIGS. 2 and 4) may execute a voice agent application (e.g., a voice assistant) in response to sensing a user utterance 910. The electronic device 800 may process the user utterance 910 using a user utterance processing system (e.g., the user utterance processing system 500 of FIG. 5). The user utterance 910 may include an inquiry and a request. Among operations of the electronic device 800, a description of operations that are substantially the same as the operations of the electronic device 800 described with reference to FIG. 8 is omitted.

According to an embodiment of the disclosure, the electronic device 800 may generate a response 912 (e.g., JSON) using a corresponding information retriever module (e.g., SmartThings) to process a request included in the user utterance 910.

According to an embodiment of the disclosure, the electronic device 800 may generate a prompt using different types of responses 911 and 912 generated by the information retriever modules. The electronic device 800 may generate a response 913 by processing the prompt using a corresponding generative model (e.g., a large language model).

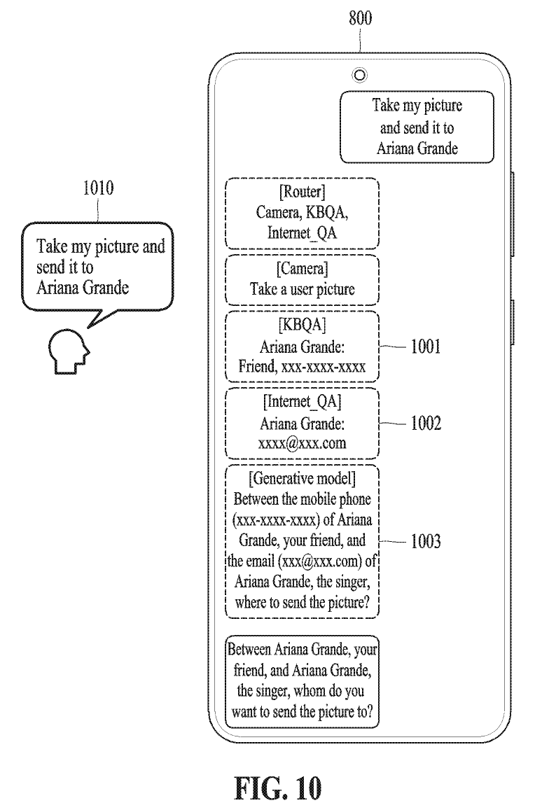

FIG. 10 is a diagram illustrating a user interface and an operation of an electronic device according to an embodiment of the disclosure.

Referring to FIG. 10, according to an embodiment of the disclosure, an electronic device 800 (e.g., the electronic device 101 of FIG. 1 and the electronic device 201 of FIGS. 2 and 4) may execute a voice agent application (e.g., a voice assistant) in response to sensing a user utterance 1010. The electronic device 800 may process the user utterance 1010 using a user utterance processing system (e.g., the user utterance processing system 500 of FIG. 5). Among operations of the electronic device 800, a description of operations that are substantially the same as the operations of the electronic device 800 described with reference to FIG. 8 is omitted.

According to an embodiment of the disclosure, the electronic device 800 may obtain information (e.g., contact or an email address) about a parameter (e.g., a recipient parameter, such as "Ariana Grande") included in the user utterance 1010, based on characteristics (e.g., intents) of the user utterance 1010. For example, the electronic device 800 may obtain a mobile phone number 1001 of Ariana Grande, who is a friend of a user, from a storage related to a contact application and may obtain an email address 1002 of Ariana Grande, who is a singer, through an Internet search.

According to an embodiment of the disclosure, the electronic device 800 may generate a response (e.g., a message 1003 requesting user verification) from the responses (e.g., the mobile phone number 1001 and the email address 1002) generated by the information retriever modules.

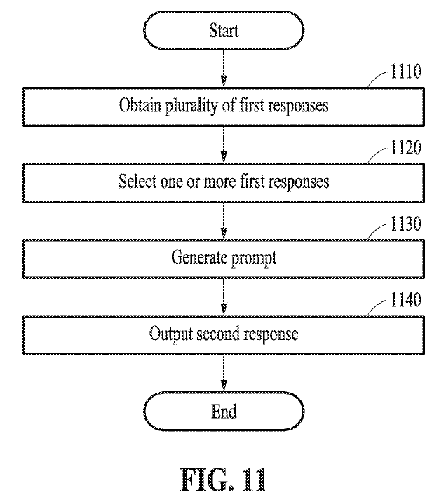

FIG. 11 is a flowchart illustrating an operation of an electronic device according to an embodiment of the disclosure.

Referring to FIG. 11, according to an embodiment of the disclosure, operations 1110 to 1130 may be sequentially performed, but the embodiment is not limited thereto. For example, two or more operations may be performed in parallel. Operations 1110 to 1130 may be substantially the same as the operations of the electronic device (e.g., the electronic device 101 of FIG. 1, the electronic device 201 of FIGS. 2 and 4, and the electronic device 800 of FIGS. 8 to 10) described with reference to FIGS. 1 to 10 and/or the operations of the user utterance processing system (e.g., the user utterance processing system 500 of FIG. 5). Accordingly, a repeated description thereof is omitted.

In operation 1110, the electronic device 101, 201, or 800 may obtain a plurality of first responses from different types of data sources based on an intent of a user utterance 610, 710, 810, 910, or 1010.

In operation 1120, the electronic device 101, 201, or 800 may select one or more first responses from the plurality of first responses based on the correlation between the user utterances 610, 710, 810, 910, and 1010.

In operation 1130, the electronic device 101, 201, or 800 may generate a prompt corresponding to one or more first responses.

In operation 1140, the electronic device 101, 201, or 800 may output a second response based on a result output by a generative model using the prompt.

The electronic device 101, 201, 800 according to an embodiment may include the processor 120. The electronic device 101, 201, 800 may include the memory 130 storing instructions. The instructions, when executed individually or collectively by the processor 120, may cause the electronic device 101, 201, 800 to obtain the plurality of first responses 803, 804, 911, 912, 1001, and 1002 from different types of data sources based on intents of the user utterances 610, 710, 810, 910, and 1010. The instructions, when executed individually or collectively by the processor 120, may cause the electronic device 101, 201, 800 to select one or more first responses from the plurality of first responses 803, 804, 911, 912, 1001, 1002 based on a correlation between each of the plurality of first responses 803, 804, 911, 912, 1001, 1002 and the user utterance 610, 710, 810, 910, 1010. The instructions, when executed individually or collectively by the processor 120, may cause the electronic device 101, 201, 800 to generate a prompt corresponding to the one or more first responses. The instructions, when executed individually or collectively by the processor 120, may cause the electronic device 101, 201, 800 to output a second response 806 based on a result output by a generative model using the prompt.

According to an embodiment of the disclosure, the instructions, when individually or collectively executed by the processor 120, may cause the electronic device 101, 201, 800 to input text corresponding to the user utterance 610, 710, 810, 910, 1010 to a plurality of information retriever modules 531 to 539 using a router 523 based on a neural network. The instructions, when executed individually or collectively by the processor 120, may cause the electronic device 101, 201, 800 to obtain the plurality of first responses 803, 804, 911, 912, 1001, 1002 using the plurality of information retriever modules 531 to 539. The data sources may respectively correspond to the plurality of information retriever modules 531 to 539.

According to an embodiment of the disclosure, the plurality of first responses 803, 804, 911, 912, 1001, 1002 may include different types of responses.

According to an embodiment of the disclosure, the plurality of information retriever modules 531 to 539 may include a first information retriever module configured to process one domain. The plurality of information retriever modules 531 to 539 may include a second information retriever module configured to process a plurality of domains.

According to an embodiment of the disclosure, the instructions, when individually or collectively executed by the processor 120, may cause the electronic device 101, 201, 800 to obtain a plurality of texts from the text based on a correlation among a plurality of intents of the user utterance 610, 710, 810, 910, 1010. The instructions, when executed individually or collectively by the processor 120, may cause the electronic device 101, 201, 800 to input each of the plurality of texts to a corresponding information retriever module.

According to an embodiment of the disclosure, the instructions, when individually or collectively executed by the processor 120, may cause the electronic device 101, 201, 800 to select the one or more first responses from the plurality of first responses 803, 804, 911, 912, 1001, 1002 using a correlation determination module 540 based on a neural network.

According to an embodiment of the disclosure, the correlation determination module 540 based on the neural network may be trained to select a candidate response including information related to the intent of the user utterance from a plurality of candidate responses.

According to an embodiment of the disclosure, the instructions, when individually or collectively executed by the processor 120, may cause the electronic device 101, 201, 800 to generate the prompt based on the one or more first responses and a prompt description corresponding to the one or more first responses.

According to an embodiment of the disclosure, the instructions, when individually or collectively executed by the processor 120, may cause the electronic device 101, 201, 800 to input the prompt to a corresponding generative model, based on at least one of a length of the prompt and a type of the prompt. The instructions, when individually or collectively executed by the processor 120, may cause the electronic device 101, 201, 800 to output the second response 806 by processing the prompt using the corresponding generative model.

According to an embodiment of the disclosure, the instructions, when individually or collectively executed by the processor 120, may cause the electronic device 101, 201, 800 to generate a plurality of third responses by processing the prompt using a plurality of generative models 561 to 569. The instructions, when individually or collectively executed by the processor 120, may cause the electronic device 101, 201, 800 to output one of the plurality of third responses as the second response 806.

A method of operating an electronic device 101, 201, 800 according to an embodiment may include obtaining a plurality of first responses 803, 804, 911, 912, 1001, 1002 from different types of data sources based on an intent of a user utterance 610, 710, 810, 910, 1010). The method may include selecting one or more first responses from the plurality of first responses 803, 804, 911, 912, 1001, 1002 based on a correlation between each of the plurality of first responses 803, 804, 911, 912, 1001, 1002 and the user utterance 610, 710, 810, 910, 1010. The method may include generating a prompt corresponding to the one or more first responses. The method may include outputting a second response 806 based on a result output by a generative model using the prompt.

According to an embodiment of the disclosure, the obtaining of the plurality of first responses 803, 804, 911, 912, 1001, 1002 may include inputting text corresponding to the user utterance 610, 710, 810, 910, 1010 to a plurality of information retriever modules 531 to 539 using a router 523 based on a neural network. The obtaining of the plurality of first responses 803, 804, 911, 912, 1001, 1002 may include obtaining the plurality of first responses 803, 804, 911, 912, 1001, 1002 using the plurality of information retriever modules 531 to 539. The data sources may respectively correspond to the plurality of information retriever modules 531 to 539.

According to an embodiment of the disclosure, the plurality of first responses 803, 804, 911, 912, 1001, 1002 may include different types of responses.

According to an embodiment of the disclosure, the plurality of information retriever modules 531 to 539 may include a first information retriever module configured to process one domain. The plurality of information retriever modules 531 to 539 may include a second information retriever module configured to process a plurality of domains.

According to an embodiment of the disclosure, the inputting of the text corresponding to the user utterance 610, 710, 810, 910, 1010 to the plurality of information retriever modules 531 to 539 may include obtaining a plurality of texts from the text based on a correlation among a plurality of intents of the user utterance 610, 710, 810, 910, 1010. The inputting of the text corresponding to the user utterance 610, 710, 810, 910, 1010 to the plurality of information retriever modules 531 to 539 may include inputting each of the plurality of texts to a corresponding information retriever module.

According to an embodiment of the disclosure, the selecting of the one or more first responses may include selecting the one or more first responses from the plurality of first responses 803, 804, 911, 912, 1001, 1002 using a correlation determination module 540 based on a neural network.

According to an embodiment of the disclosure, the correlation determination module 540 based on the neural network may be trained to select a candidate response including information related to the intent of the user utterance from a plurality of candidate responses.

According to an embodiment of the disclosure, the generating of the prompt may include generating the prompt based on the one or more first responses and a prompt description corresponding to the one or more first responses.

According to an embodiment of the disclosure, the generating of the second response may include inputting the prompt to a corresponding generative model, based on at least one of a length of the prompt and a type of the prompt. The generating of the second response 806 may include outputting the second response 806 by processing the prompt by using the corresponding generative model.

According to an embodiment of the disclosure, the generating of the second response 806 may include generating a plurality of third responses by processing the prompt using a plurality of generative models 561 to 569. By processing the prompt using the corresponding generative model, the generating of the second response 806 may include outputting one of the plurality of third responses as the second response 806.

According to an embodiment of the disclosure, a non-transitory computer-readable storage medium storing one or more computer programs may include instructions that cause the processor 120 to perform the method of operating the electronic device 101, 201, 800.

The electronic device according to various embodiments described herein may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspects (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs including instructions that, when executed, implement various embodiments of the disclosure. Accordingly, various embodiments provide a program including code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one processor comprising processing circuitry; and
memory, comprising one or more storage media, storing instructions,
wherein the instructions, when executed by the at least one processor individually or collectively, cause the electronic device to:
obtain a plurality of first responses from different types of data sources based on an intent of a user utterance,
select one or more first responses from the plurality of first responses based on a correlation between each of the plurality of first responses and the user utterance,
generate a prompt corresponding to the one or more first responses, and
output a second response based on a result output by a generative model using the prompt.

2. The electronic device of claim 1,
wherein the instructions, when executed by the at least one processor individually or collectively, further cause the electronic device to:
input text corresponding to the user utterance to a plurality of information retriever modules using a router based on a neural network, and
obtain the plurality of first responses using the plurality of information retriever modules, and
wherein the data sources respectively correspond to the plurality of information retriever modules.

3. The electronic device of claim 1, wherein the plurality of first responses comprises different types of responses.

4. The electronic device of claim 2, wherein the plurality of information retriever modules comprises:
a first information retriever module configured to process one domain; and
a second information retriever module configured to process a plurality of domains.

5. The electronic device of claim 2, wherein the instructions, when executed by the at least one processor individually or collectively, further cause the electronic device to:
obtain a plurality of texts from the text based on a correlation among a plurality of intents of the user utterance, and
input each of the plurality of texts to a corresponding information retriever module.

6. The electronic device of claim 1, wherein the instructions, when executed by the at least one processor individually or collectively, individually or collectively cause the electronic device to:
generate the prompt based on the one or more first responses and a prompt description corresponding to the one or more first responses, and
output the second response based on processing the prompt using the generative model.

7. The electronic device of claim 6, wherein the instructions, when executed by the at least one processor individually or collectively, individually or collectively cause the electronic device to:
input the prompt to a corresponding generative model, based on at least one of a length of the prompt and a type of the prompt, and
output the second response by processing the prompt using the corresponding generative model.

8. The electronic device of claim 7, wherein the instructions, when executed by the at least one processor individually or collectively, individually or collectively cause the electronic device to:
generate a plurality of third responses by processing the prompt using a plurality of generative models, and
output one of the plurality of third responses as the second response.

9. A method of operating an electronic device, the method comprising:
obtaining a plurality of first responses from different types of data sources based on an intent of a user utterance;
selecting one or more first responses from the plurality of first responses based on a correlation between each of the plurality of first responses and the user utterance;
generating a prompt corresponding to the one or more first responses; and
outputting a second response based on a result output by a generative model using the prompt.

10. The method of claim 9,
wherein the obtaining of the plurality of first responses comprises:
inputting text corresponding to the user utterance to a plurality of information retriever modules using a router based on a neural network; and
obtaining the plurality of first responses using the plurality of information retriever modules,
wherein the data sources respectively correspond to the plurality of information retriever modules.

11. The method of claim 9, wherein the plurality of first responses comprises different types of responses.

12. The method of claim 10, wherein the plurality of information retriever modules comprises:
a first information retriever module configured to process one domain; and
a second information retriever module configured to process a plurality of domains.

13. The method of claim 10, wherein the inputting of the text corresponding to the user utterance to the plurality of information retriever modules comprises:
obtaining a plurality of texts from the text based on a correlation among a plurality of intents of the user utterance, and
inputting each of the plurality of texts to a corresponding information retriever module.

14. The method of claim 9, wherein the generating of the prompt comprises:
generating the prompt based on the one or more first responses and a prompt description corresponding to the one or more first responses.

15. The method of claim 14, wherein the generating of the second response comprises:
inputting the prompt to a corresponding generative model, based on at least one of a length of the prompt and a type of the prompt, and
outputting the second response based on processing the prompt using the corresponding generative model.

16. The method of claim 15, further comprising:
inputting the prompt to a corresponding generative model, based on at least one of a length of the prompt and a type of the prompt; and
outputting the second response by processing the prompt using the corresponding generative model.

17. The method of claim 16, further comprising:
generating a plurality of third responses by processing the prompt using a plurality of generative models; and
outputting one of the plurality of third responses as the second response.

18. One or more non-transitory computer-readable storage media storing one or more computer programs including computer-executable instructions that, when executed by one or more processors of an electronic device individually or collectively, cause the electronic device to perform operations, the operations comprising:
obtaining a plurality of first responses from different types of data sources based on an intent of a user utterance;
selecting one or more first responses from the plurality of first responses based on a correlation between each of the plurality of first responses and the user utterance;
generating a prompt corresponding to the one or more first responses; and
outputting a second response based on a result output by a generative model using the prompt.

19. The one or more non-transitory computer-readable storage media of claim 18,
wherein the obtaining of the plurality of first responses comprises:
inputting text corresponding to the user utterance to a plurality of information retriever modules using a router based on a neural network; and
obtaining the plurality of first responses using the plurality of information retriever modules,
wherein the data sources respectively correspond to the plurality of information retriever modules.
